(19) United States
(12) Patent Application Publication
(10) Pub. No.: US 2006/0072585 A1
(43) Pub. Date: Apr. 6, 2006

(54) Network-connecting method dispensing with IP configuration

(76) Inventor: Chia-Li Hung, Banciao City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/948,174

(22) Filed: Sep. 24, 2004

(51) Int. Cl. H04L 12/56

(52) U.S. Cl. 370/395.54

(57) ABSTRACT

A network-connecting method dispenses with IP configuration and enables a computer accessing a network through a network device. The computer sends a data packet containing a destination IP address. The network device receives the data packet and judges whether the data packet is an address resolution protocol (ARP) packet. The network device judges whether a default IP address for a gateway of the computer exists when the data packet is an ARP packet. The network device sends an MAC address of the network device to the computer when the default IP address does not exist, whereby the network device acts as a gateway of the computer and exchanges packet between the computer and the network. The computer can automatically access network without the effort of resetting IP configuration.

### BACKGROUND OF THE INVENTION

1. Field of the invention

The present invention relates to a network-connecting method dispensing with IP configuration, especially to a network-connecting method using a network device such as modem, router, gateway or WAP for connecting a computer to a network without the need to set IP configuration for the computer.

2. Description of the Prior Art

The prevailing computer and network technology make people to routinely access Internet through computer at their home or their office. To link a computer to a network, the computer should be assigned with a unique IP configuration. For example, in TCP/IP network, each computer has its unique IP configuration to identify the location thereof. The formats of IP configuration are different in local area network (LAN) and wide area network (WAN).

In some situation, the IP configuration of a computer should be reconfigured. For example, two identical IP configurations for computers are present in a network, or a computer has wrong IP configuration, or a computer is moved to another network.

Moreover, as the prevalence of mobile computing, new notebook computers are generally equipped with wireless LAN card for wireless connection to a wireless access point (WAP). Therefore, users can access Internet freely in restaurants or bookstores by their notebook computers.

The mobility for wireless network accessing is limited by the IP configuration of the notebook computer. More particularly, the IP configuration of the notebook computer requires reconfiguration if the notebook computer is brought to other place for wireless network accessing.

For example, if the IP address in an office is 192.168.10.X and a home IP address is 192.168.1.1 for a user, the user should change the IP address setting in his computer to 192.168.1.1 when he brings his computer from office to home for accessing network. Moreover, the user should change the IP address setting in his computer back to 192.168.10.X when he brings his computer from home to office for accessing network in office.

As can be seen from above description, the IP configuration for network is an issue for user especially when he want to access network in different places and the IP configuration for network is not easy for ordinary user.

### SUMMARY OF THE INVENTION

It is the object of the present invention to provide a network-connecting method using a network device for connecting a computer to a network without the need to set IP configuration for the computer.

To achieve the above object, the present invention provides a network-connecting method dispensing with IP configuration and enabling a computer accessing a network through a network device. The computer sends a data packet containing a destination IP address. The network device receives the data packet and judges whether the data packet is an address resolution protocol (ARP) packet. The network device judges whether a default IP address for a gateway of the computer exists when the data packet is an ARP packet. The network device sends an MAC address of the network device to the computer when the default IP address does not exist, whereby the network device acts as a gateway of the computer and exchanges packet between the computer and the network. The computer can automatically access network without the effort of resetting IP configuration.

In one aspect of the present invention, the computer is determined for not moving to new network, if the network identifies the data packet being not an ARP packet. Therefore, the computer will access network by a default gateway already set therein and the gateway will exchange data packet between the computer and the network.

In another aspect of the present invention, the computer is determined for moving to new network and the computer still uses default gateway, if the network identifies the data packet being an ARP packet and the default gateway exists.

The above summaries are intended to illustrate exemplary embodiments of the invention, which will be best understood in conjunction with the detailed description to follow, and are not intended to limit the scope of the appended claims.

### BRIEF DESCRIPTION OF DRAWING

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 shows a schematic diagram of the application for the present invention;

FIG. 2 shows a flowchart of the network-connecting method according to the present invention;

FIG. 3 shows a flowchart of the automatic detection scheme according to the present invention;

FIG. 4 shows the message asking user to examine network connection;

FIG. 5 shows the message for asking the user to wait for a moment;

FIG. 6 shows the message for user to find help from ISP; and

FIG. 7 shows the message to ask user to input user name and password again.

### DETAILED DESCRIPTION OF THE INVENTION

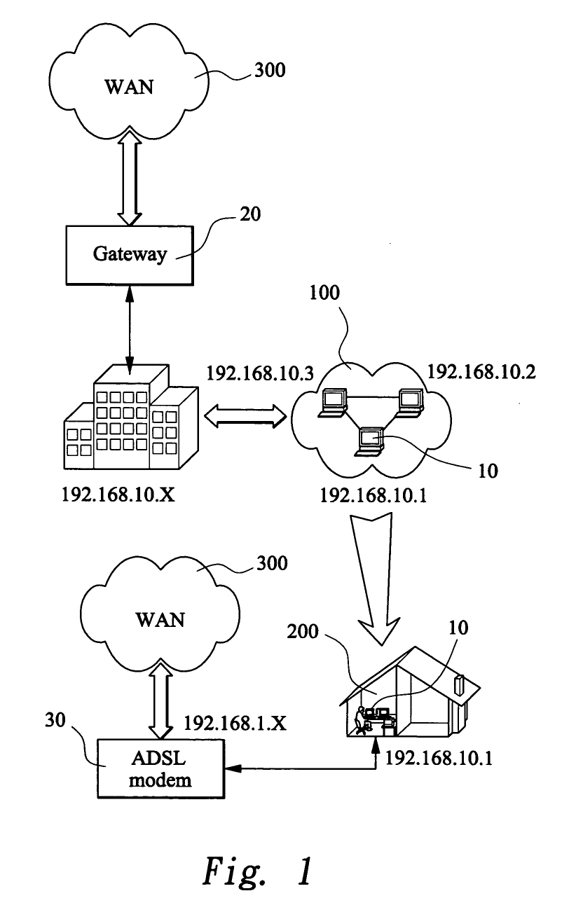

FIG. 1 shows a schematic diagram of the application for the present invention. The present invention is intended to solve the problem of reconfiguring IP configuration when a computer 10 is moved from a first network to a second network. In FIG. 1, the first network is exemplified as office LAN 100 and the second network is exemplified as home LAN 200 for description.

The office LAN 100 generally comprises a plurality of computers sharing one set or multiple sets IP addresses. The IP address for each computer in the office LAN 100 is assigned automatically by dynamic host configuration protocol (DHCP) or manually. After configuration, the computer is connected to a WAN 300 such as Internet through a network gateway 20 within the office. Moreover, in this example, the IP address of network gateway 20 is 192.168.10.X, and the IP address of the exemplified computer is assumed to be 192.168.10.1.

When user brings his computer 10 back home for connecting to home LAN 200, the computer 10 might be connected to the WAN 300 such as Internet through dialup service, for example, through an ADSL modem (ATU-R) 30. If the IP address of the ADSL modem 30 is 192.168.1.X, the user should manually set the IP address of the computer 10 to 192.168.1.1 if DHCP is not involved.

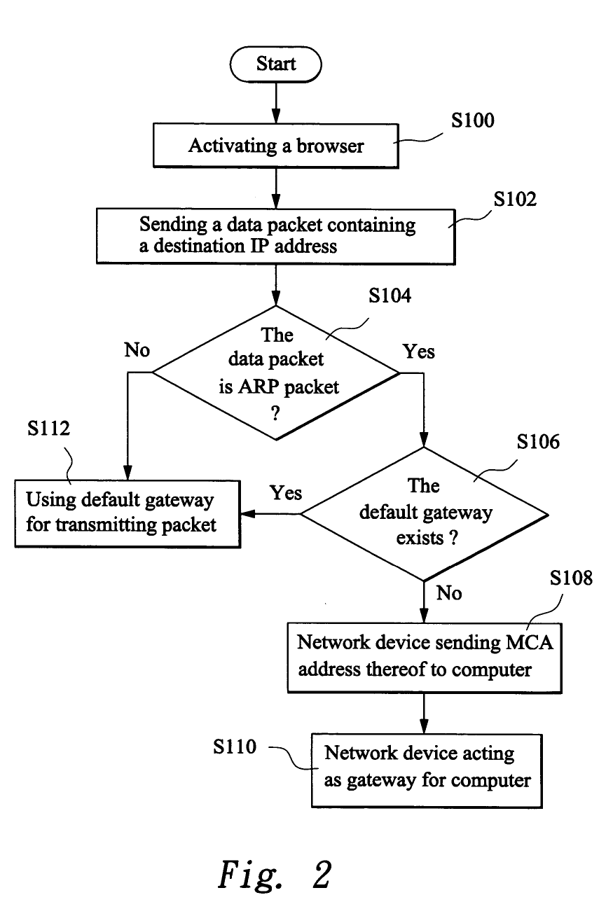

FIG. 2 shows a flowchart of the network-connecting method according to the present invention. In the present invention, a network device is installed with a zero configure connecting procedure for connecting a computer to a network without the effort of resetting IP configuration. The network device can be, for example, an ADSL modem, a router, a gateway, a hub, a IP sharing or WAP. The network can be a LAN 100 or a WAN 300.

When the user moves the computer 10 from office to home, the computer 10 is linked to the network device either through wired network card or wireless network card and accesses the network without the effort of resetting IP configuration in the computer 10

The zero configure connecting procedure according to the present invention first activates a browser software, an e-mail software or any network software on the computer 10 at step S100. The computer 10 then sends a data packet containing a destination IP address in step S102. The IP address can be the IP address of any server such as Yahoo server or the IP address of any computer in the LAN.

The network device will judges whether the data packet is an address resolution protocol (ARP) packet instead of a packet asking the MCA address of the network device per se in step S104 after the network device receives the data packet containing the destination IP address.

If the data packet is an ARP packet, the network device will judge whether the address of the default gateway in the computer 10 exists in step S106. If the address of the default gateway of office network for the computer 10 is 192.168.10.X, then the request sent to the address 192.168.10.X will not be responded after the computer 10 is moved to home.

At this time, the network device will send the MCA address thereof to the computer 10 in step S108. The computer 10 will send data packet to the MCA address of the network device such that the network device is functioned as the gateway of the computer 10 at step S110. Therefore, the network device will process the packet sent by the computer 10 and is simulated as the computer 10 with respect to destination end. In other word, the network device will interchange packet with the destination IP address in step S112.

The MCA address is unique for any network interface card. The computers in a network can communicate to each other when the MCA address of the gateway is known. Therefore, the computer can exchange data packet with the network device when the computer knows the MCA address of the network device. Through the network device, the computer can exchange data packet to any destination device without the effort of resetting IP configuration.

If the data packet received by the network device is not an ARP packet in step S104, the computer 10 will send data packet to a default gateway 20 and the default gateway 20 will transfer the data packet to the destination IP address in step S112. For example, the computer 10 in office generally transmits data packet to external WAN through a gateway.

Moreover, if the data packet received by the network device is an ARP packet in step S104 and the address of the default gateway in the computer 10 exists in step S106, then the computer 10 will send data packet to the default gateway and the default gateway 20 transfers the data packet to the destination IP address in step S112. For example, if the computer is moved to office again and connected to network for the first time, the computer will be connected to network through this way.

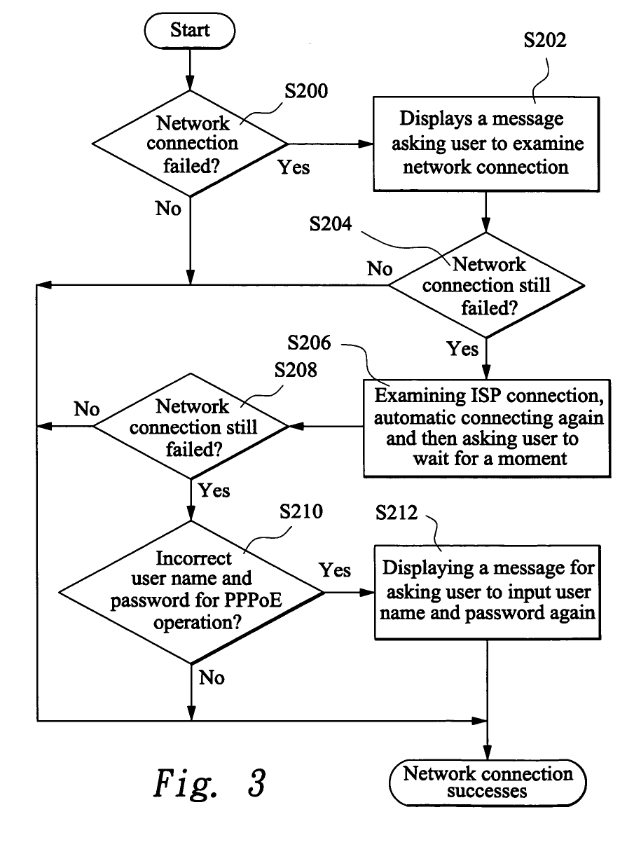

The above-mentioned situation is applied for network in normal connection. Moreover, the present invention also provides an automatic detection scheme for computer accessing network for the first time or failing to access network. The automatic detection scheme can set up IP configuration automatically for user. FIG. 3 shows the flowchart of the automatic detection scheme.

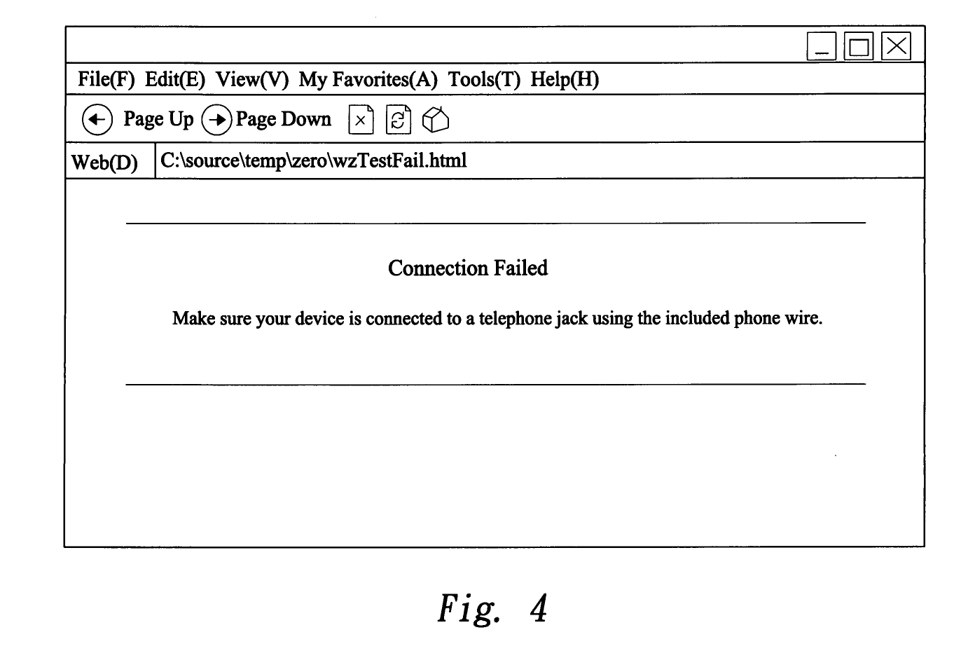

As shown in FIG. 3, if the computer 10 cannot send or exchange data packet in step S200, the network device sends a message to the computer 10 such that the browser in the computer 10 displays a message asking user to examine network connection in step S202. FIG. 4 shows the message asking user to examine network connection.

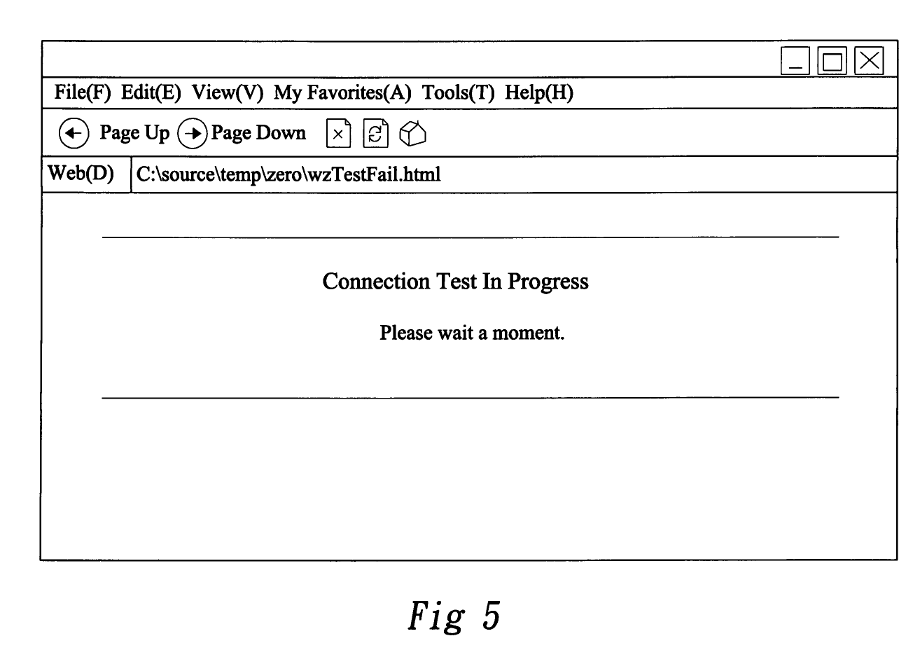

If the network connection of the network device is correct after examination and the computer 10 cannot send or exchange data packet in step S204, the network device will examine the connection status with the ISP office end. Afterward the network device will again establish network connection and send a message to browser for asking the user to wait for a moment in step S206. FIG. 5 shows the message for asking the user to wait for a moment.

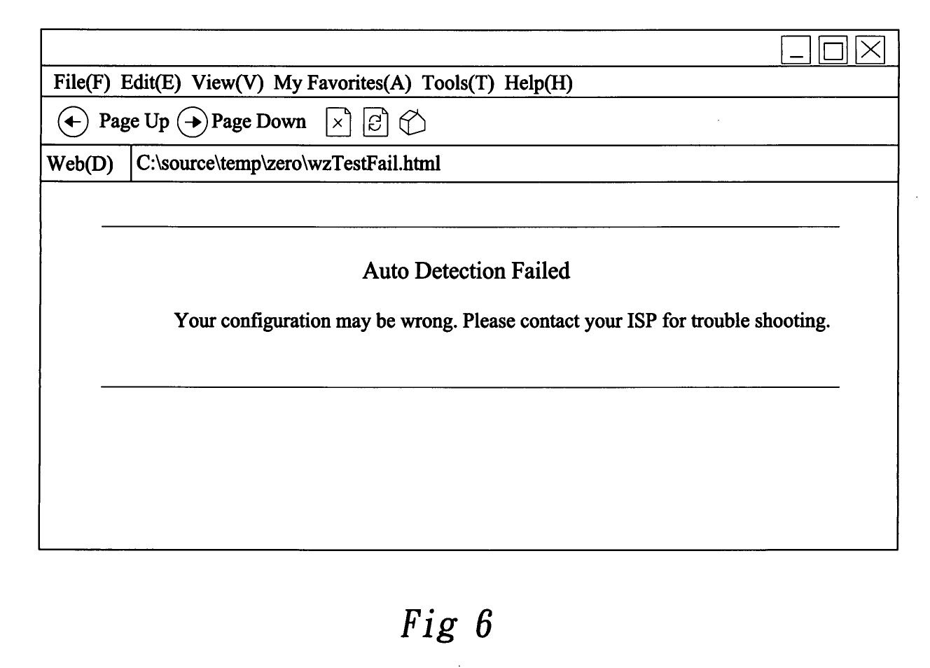

If the reconnection still fails, a message is displayed on browser to ask user to find help from ISP as shown in FIG. 6.

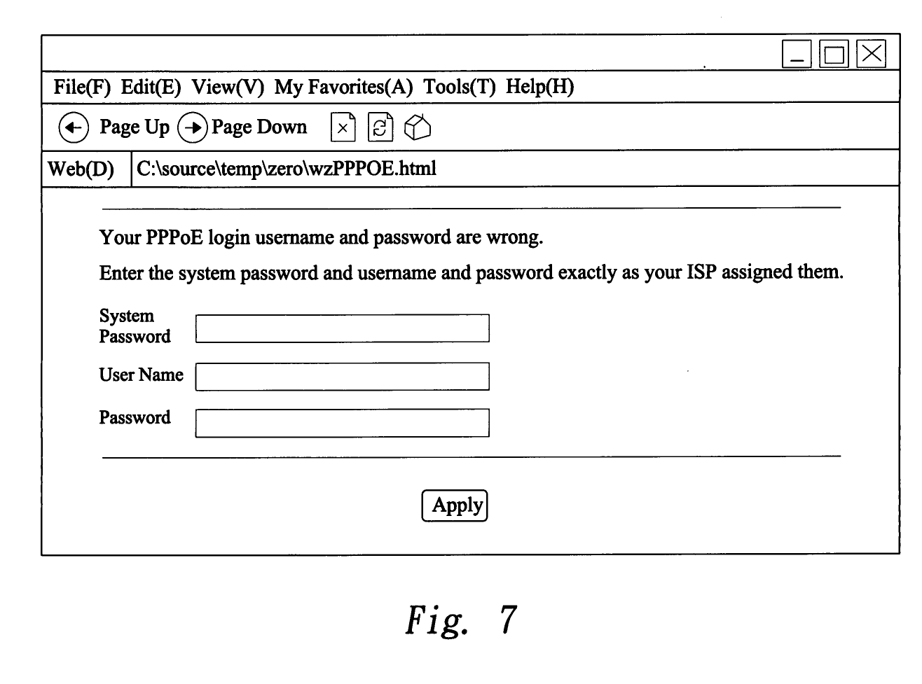

If the reconnection successes but the network is not accessible, the network device will examine the correctness of the user name and password for PPPoE (Point to Point Protocol over Ethernet) operation in step S210. If the user name and password are not correct for PPPoE operation, a message is sent to browser to ask user to input user name and password again in step S212, as shown in FIG. 7. The input user name and password are saved if they are correct, whereby the network connection can be automatically achieved.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. A network-connecting method dispensing with IP configuration, the method enabling a computer accessing a network through a network device and comprising the steps of:
(a) the computer sending a data packet containing a destination IP address;
(b) the network device receiving the data packet and judging whether the data packet is an address resolution protocol (ARP) packet;
(c) judging whether a default IP address for a gateway of the computer exists when the data packet is an ARP packet; and
(d) sending an MAC address of the network device to the computer when the default IP address for the gateway of the computer does not exist, whereby the network device acts as a gateway of the computer and exchanges packet between the computer and the network.

2. The network-connecting method as in claim 1, wherein the network device is one of an ADSL modem, a router, a gateway, a hub, a IP sharing and wireless access point (WAP).

3. The network-connecting method as in claim 1, wherein the network is one of a local area network (LAN) and a wide-area network (WAN).

4. The network-connecting method as in claim 1, farther comprising a step before the step (a):
activating a browser software, an e-mail software or any network software on the computer.

5. The network-connecting method as in claim 1, wherein the destination IP address in the step (a) is an IP address of any server or an IP address of any computer in a LAN.

6. The network-connecting method as in claim 1, wherein in the step (a) the computer is connected to the network device through a wired network card or a wireless network card.

7. The network-connecting method as in claim 1, further comprising a step after the step (b):
sending packet to a gateway according to a default gateway address therein when the data packet is not an ARP packet; the packet sent by the computer being sent to destination IP address through the gateway.

8. The network-connecting method as in claim 1, further comprising a step after the step (d):
sending packet to the gateway according to a default gateway address therein when the gateway of the computer exists; the packet sent by the computer being sent to destination IP address through the gateway.

9. The network-connecting method as in claim 1, further comprising a step after the step (d):
displaying a message on the computer to ask user to examine connection between the network device and the network when the computer cannot send or receive packet.

10. The network-connecting method as in claim 1, further comprising steps after the step (d):
the network device examining a user name and a password for accessing the network when the computer cannot send or receive packet;
displaying a message on the computer to ask user to input correct user name and password when the user name and the password for accessing the network are not correct; and
saving the input user name and password.
